(19) United States
(12) Patent Application Publication
(10) Pub. No.: US 2026/0020674 A1
(43) Pub. Date: Jan. 22, 2026

(54) RHYTHM DEVICE AND RHYTHM CHAIR

(71) Applicant: KUANG YU METAL WORKING CO., LTD., Changhua County (TW)

(72) Inventors: Wen-Hsu HSIEH, Changhua County (TW); Wen Chieh SHIH, Changhua County (TW)

(21) Appl. No.: 19/275,911

(22) Filed: Jul. 21, 2025

(30) Foreign Application Priority Data
Jul. 22, 2024 (TW) 113127280
Dec. 31, 2024 (TW) 113151621
Jul. 8, 2025 (TW) 114207157

(51) Int. Cl. A47C 3/025; A61H 23/02

(52) U.S. Cl. CPC A47C 3/0251; A47C 3/0255; A61H 23/0254; A61H 2201/0149; A61H 2203/0431; A61H 2205/086

(57) ABSTRACT

A rhythm device includes a base, a vibration driving mechanism, a vibration linkage mechanism, a swing driving mechanism, a swing linkage mechanism and a suspension frame. The vibration linkage mechanism is driven by the vibration driving mechanism and includes a transmission board, a supporting board and a vibrating arm. The transmission board includes a lower end pivoted on the vibration driving axle. The supporting board includes a fixed end fixed at the base. The vibrating arm is pivoted on the pivoting end directly pivoted on the upper end of the transmission board. The swing linkage mechanism is driven by the swing driving mechanism eccentrically and includes four swinging arms, and the top end of one of the four swinging arms is directly pivoted on the vibrating arm. The suspension frame is pivoted on the swinging arms.

### RELATED APPLICATIONS

This application claims priority to Taiwan Application Serial Number 113127280, filed Jul. 22, 2024, Taiwan Application Serial Number 113151621, filed Dec. 31, 2024, and Taiwan Application Serial Number 114207157, filed Jul. 8, 2025, which are herein incorporated by reference.

### BACKGROUND

### Technical Field

The present disclosure relates to a rhythm device and a rhythm chair. More particularly, the present disclosure relates to a rhythm device and a rhythm chair which may generate a vibration and a horizontal swing.

### Description of Related Art

Rhythm devices may generate vibrations which move a human body to vibrate organs or muscles, thereby achieving effects of exercise and blood circulation.

The conventional rhythm devices may include a motor to drive an eccentric axle, thereby allowing a linkage assembly to oscillate and generate a vertical or wave vibration. However, in order to generate the vertical or wave vibration, lots of linkage rods and pivots are required, which leads to a disadvantage of complex structure. Additionally, the conventional rhythm device does not have a horizontal swing function, and improvement thereof is required.

### SUMMARY

According to one aspect of the present disclosure, a rhythm device includes a base, a vibration driving mechanism, a vibration linkage mechanism, a swing driving mechanism, a swing linkage mechanism and a suspension frame. The vibration driving mechanism is disposed at the base and includes a vibration motor and a vibration driving axle, and the vibration driving axle is rotated by the vibration motor. The vibration linkage mechanism is driven by the vibration driving mechanism eccentrically and includes a transmission board, a supporting board and a vibrating arm. The transmission board includes an upper end and a lower end opposite to each other, and the lower end is pivoted on one end of the vibration driving axle. The supporting board includes a fixed end and a pivoting end, and the fixed end is fixed at the base. The vibrating arm is pivoted on the pivoting end and includes an inner side end and an outer side end, and the inner side end is directly pivoted on the upper end of the transmission board. The swing driving mechanism is disposed at the base and includes a swing motor and a swing driving axle, and the swing driving axle is rotated by the swing motor. The swing linkage mechanism is driven by the swing driving mechanism eccentrically and includes four swinging arms. The four swinging arms are arranged at two sides of the base symmetrically, each of the four swinging arms includes a top end and a bottom end, and the top end of one of the four swinging arms is directly pivoted on the outer side end of the vibrating arm. The suspension frame is pivoted on the bottom ends of the four swinging arms. The vibration motor drives the vibration driving axle to vibrate the vibrating arm with the pivoting end of the supporting board as a pivot, and the one of the four swinging arms is driven to vibrate the suspension frame; the swing motor drives the swing driving axle to drive the swing linkage mechanism, thereby swinging the suspension frame horizontally.

According to another aspect of the present disclosure, a rhythm device includes a base, a vibration driving mechanism, two vibration linkage mechanisms, a swing driving mechanism, a swing linkage mechanism and a suspension frame. The vibration driving mechanism is disposed at the base and includes a vibration motor and a vibration driving axle, and the vibration driving axle is rotated by the vibration motor. The two vibration linkage mechanisms are disposed at two sides of the base symmetrically and driven by the vibration driving mechanism eccentrically. Each of the vibration linkage mechanisms includes a transmission board, and a supporting board, and a vibrating arm. The transmission board includes an upper end and a lower end opposite to each other, and the lower end is pivoted on one end of the vibration driving axle. The supporting board includes a fixed end and a pivoting end, and the fixed end is fixed at the base. The vibrating arm is pivoted on the pivoting end and includes an inner side end and an outer side end, and the inner side end is directly pivoted on the upper end of the transmission board. The swing driving mechanism is disposed at the base and includes a swing motor and a swing driving axle, and the swing driving axle is rotated by the swing motor. The swing linkage mechanism is driven by the swing driving mechanism eccentrically and includes two swinging arms. The two swinging arms are arranged at the two sides of the base symmetrically, and each of the two swing arms includes a top end and a bottom end. The top end of the swinging arm located at one of the two sides is directly pivoted on the outer side end of one of the vibrating arms, and the top end of the swinging arm located at another one of the two sides is directly pivoted on the outer side end of another one of the vibrating arms. The suspension frame is pivoted on the bottom ends of the two swinging arms. The vibration motor drives the vibration driving axle to vibrate the vibrating arm with the pivoting end of the supporting board as a pivot, and the two swinging arms are driven to vibrate the suspension frame; the swing motor drives the swing driving axle to drive the swing linkage mechanism, thereby swinging the suspension frame horizontally.

According to still another aspect of the present disclosure, a rhythm chair includes a rhythm device and a chair frame disposed at the suspension frame.

### BRIEF DESCRIPTION OF THE DRAWINGS

The present disclosure can be more fully understood by reading the following detailed description of the embodiment, with reference made to the accompanying drawings as follows:

FIG. 1 is a three-dimensional schematic view of a rhythm chair according to one embodiment of the present disclosure.

FIG. 2 is a top view of a rhythm device of the rhythm chair of the embodiment of FIG. 1.

FIG. 3 is one partial exploded view of the rhythm device of the embodiment of FIG. 1.

FIG. 4 is another partial exploded view of the rhythm device of the embodiment of FIG. 1.

FIG. 5 is still another partial exploded view of the rhythm device of the embodiment of FIG. 1.

FIG. 6 is a side view of the rhythm device of the embodiment of FIG. 1.

### DETAILED DESCRIPTION

The embodiments of the present disclosure will be illustrated with drawings hereinafter. In order to clearly describe the content, many practical details will be mentioned with the description hereinafter. However, it will be understood by the reader that the practical details will not limit the present disclosure. In other words, in some embodiment of the present disclosure, the practical details are not necessary. Additionally, in order to simplify the drawings, some conventional structures and elements will be illustrated in the drawings in a simple way; the repeated elements may be labeled by the same or similar reference numerals.

In addition, the terms first, second, third, etc., are used herein to describe various elements or components, these elements or components should not be limited by these terms. Consequently, a first element or component discussed below could be termed a second element or component. Moreover, the combinations of the elements, the components, the mechanisms and the modules are not well-known, ordinary or conventional combinations, and whether the combinations can be easily completed by the one skilled in the art cannot be judged based on whether the elements, the components, the mechanisms or the module themselves are well-known, ordinary or conventional.

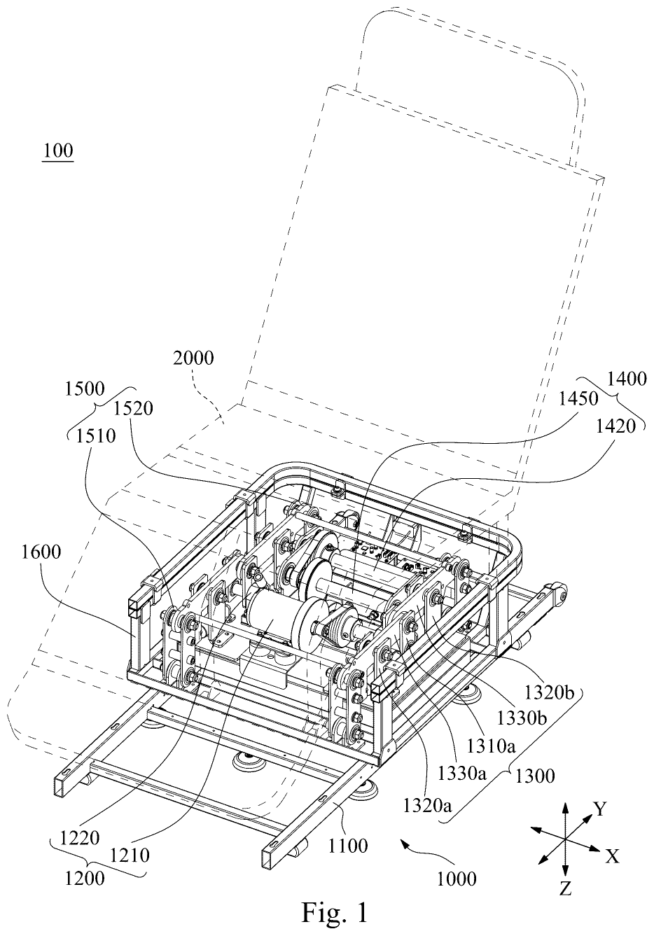

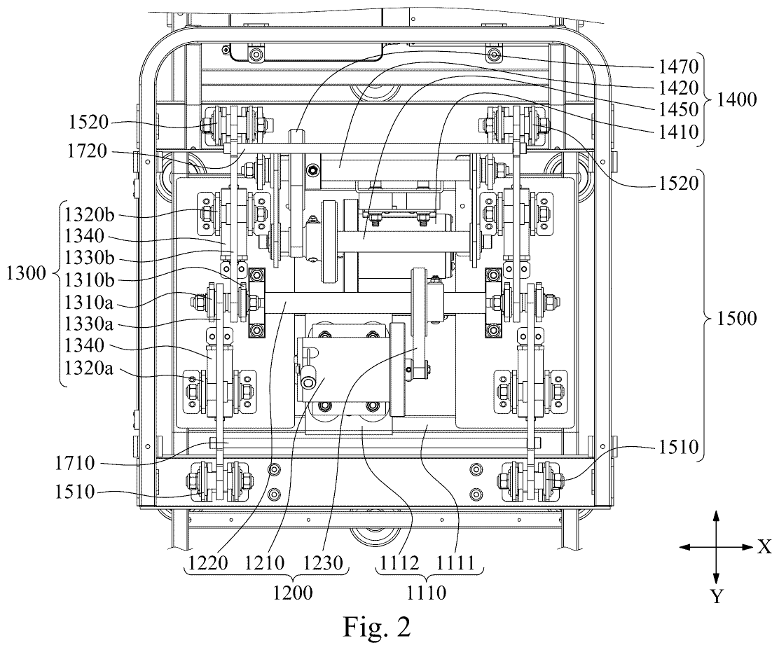

FIG. 1 is a three-dimensional schematic view of a rhythm chair 100 according to one embodiment of the present disclosure. FIG. 2 is a top view of a rhythm device 1000 of the rhythm chair 100 of the embodiment of FIG. 1. The rhythm device 1000 includes a base 1100, a vibration driving mechanism 1200, two vibration linkage mechanisms 1300, a swing driving mechanism 1400, a swing linkage mechanism 1500 and a suspension frame 1600.

The vibration driving mechanism 1200 is disposed at the base 1100 and includes a vibration motor 1210 and a vibration driving axle 1220, and the vibration driving axle 1220 is rotated by the vibration motor 1210. The vibration linkage mechanisms 1300 are disposed at two sides of the base 1100 symmetrically and driven by the vibration driving mechanism 1200 eccentrically, and a line parallel to Y axis is served as a central line of the two sides. Each of the vibration linkage mechanisms 1300 includes a transmission board 1310a, a supporting board 1320a and a vibrating arm 1330a. The transmission board 1310a includes an upper end and a lower end opposite to each other, and the lower end is pivoted on one end of the vibration driving axle 1220. The supporting board 1320a includes a fixed end and a pivoting end, and the fixed end is fixed at the base 1100. The vibrating arm 1330a is pivoted on the pivoting end of the supporting board 1320a and includes an inner side end and an outer side end, and the inner side end is directly pivoted on the upper end of the transmission board 1310a.

The swing driving mechanism 1400 is disposed at the base 1100 and includes a swing motor 1410 and a swing driving axle 1420, and the swing driving axle 1420 is rotated by the swing motor 1410. The swing linkage mechanism 1500 is driven by the swing driving mechanism 1400 eccentrically and includes four swinging arms 1510, 1520. The four swinging arms 1510, 1520 are arranged at the two sides of the base 1100 symmetrically, one of the swinging arms 1510 and one of the swinging arms 1520 are arranged at an interval at one of the sides, and the other one of the swinging arms 1510 and the other one of the swinging arms 1520 are arranged at an interval at the other one of the sides. Each of the four swinging arms 1510, 1520 includes a top end and a bottom end, the top end of the swinging arm 1520 located at one of the two sides is directly pivoted on the outer side end of one of the vibrating arms 1330a, and the top end of the swinging arm 1520 located at another one of the two sides is directly pivoted on the outer side end of another one of the vibrating arms 1330a. The suspension frame 1600 is pivoted on the bottom ends of the four swinging arms 1510, 1520. The vibration motor 1210 drives the vibration driving axle 1220 to vibrate the vibrating arm 1330a with the pivoting end of the supporting board 1320a as a pivot, and the four swinging arms 1510, 1520 are driven to vibrate the suspension frame 1600; the swing motor 1410 drives the swing driving axle 1420 to drive the swing linkage mechanism 1500, thereby swinging the suspension frame 1600 horizontally.

Therefore, with the swinging arms 1510, 1520 pivoted on the suspension frame 1600, the swing driving mechanism 1400 may drive the swinging arms 1510, 1520 to swing the suspension frame 1600 horizontally, and with the vibrating arms 1330a to be directly pivoted on the swinging arms 1510, 1520, there is no need to adapt lots linkage rods and pivots, thereby achieving an advantage of simplified structures.

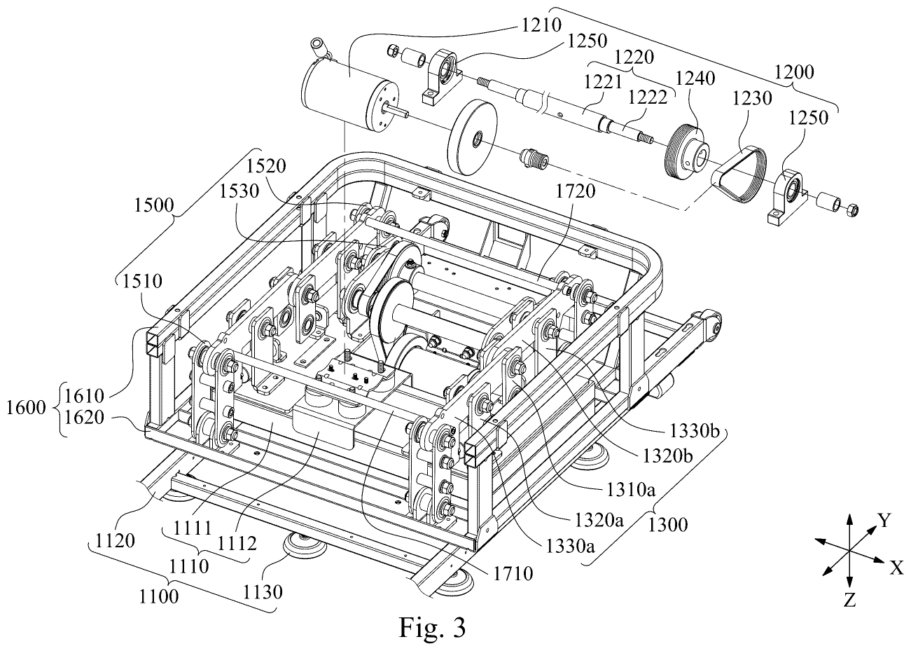

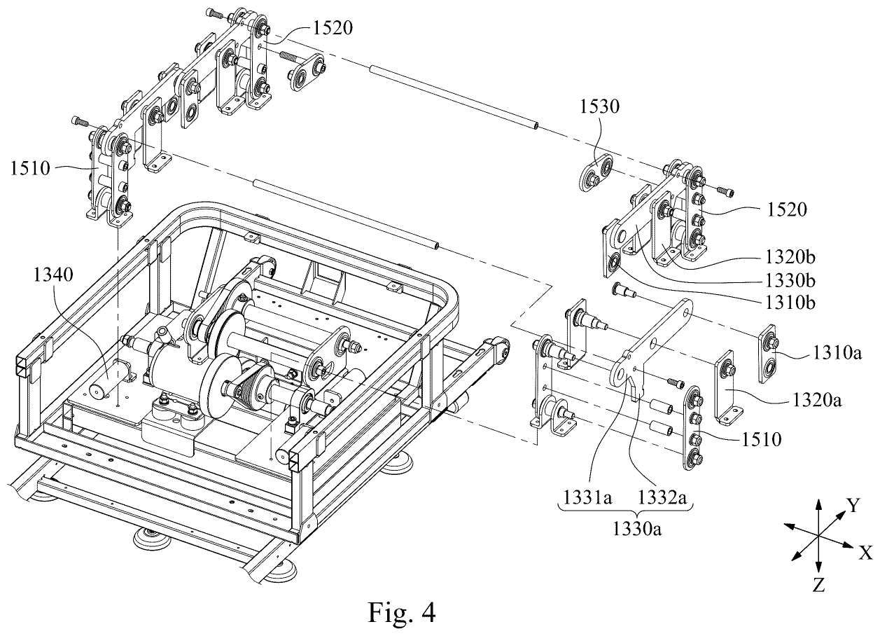

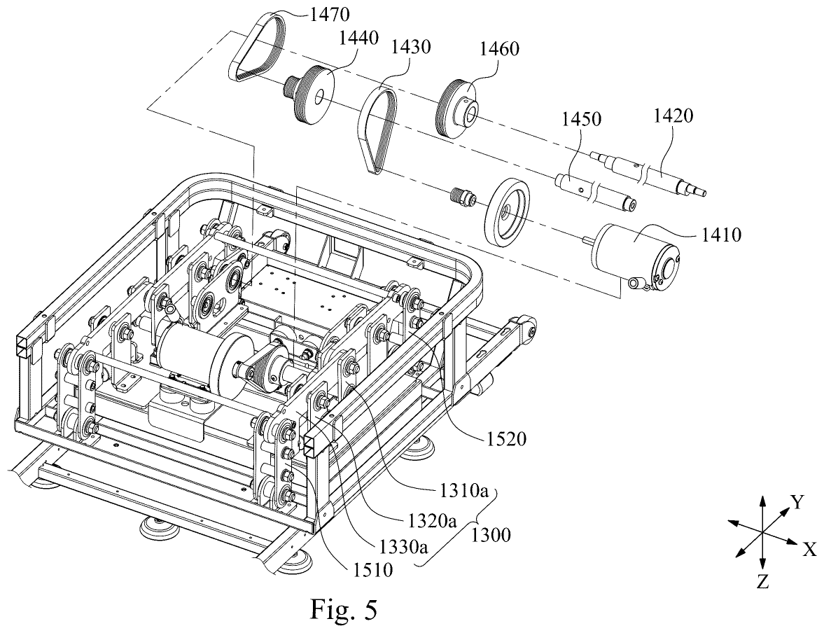

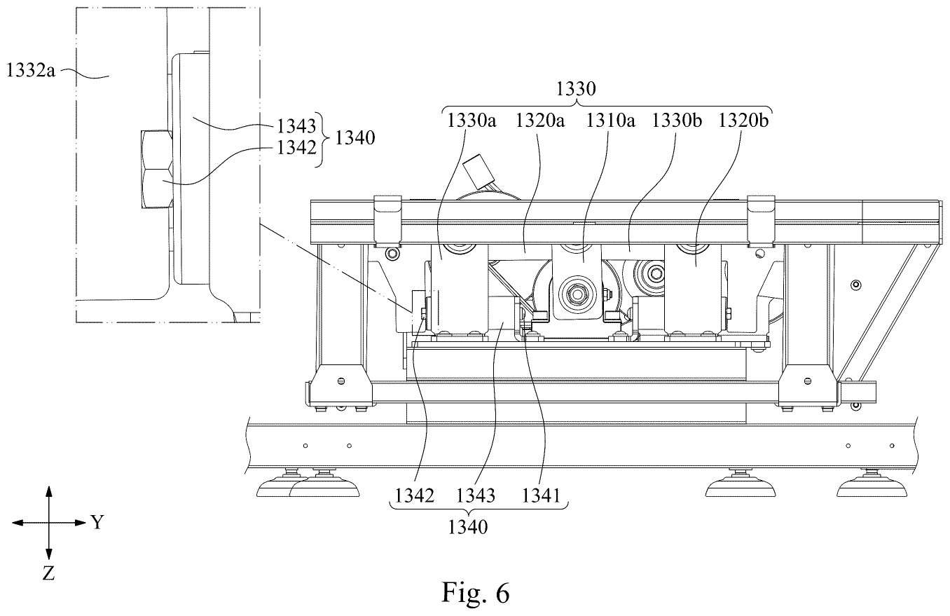

FIG. 3 is one partial exploded view of the rhythm device 1000 of the embodiment of FIG. 1. FIG. 4 is another partial exploded view of the rhythm device 1000 of the embodiment of FIG. 1. FIG. 5 is still another partial exploded view of the rhythm device 1000 of the embodiment of FIG. 1. FIG. 6 is a side view of the rhythm device 1000 of the embodiment of FIG. 1. The base 1100 may include a rectangular frame 1110, a supporting frame 1120 and a plurality of cushion pads 1130. The rectangular frame 1110 includes two side boards (not labeled), a plurality of crossbar portions 1111 and a plurality of carrier board portions 1112. The two side boards are parallel to the Y axis. The carrier board portion 1112 is parallel to an X axis and fastened between two of the crossbar portions 1111 for carrying the elements. The supporting frame 1120 may include two main rod body (not labeled) parallel to the Y axis and respectively connected to the bottoms of the two side boards for supporting the rectangular frame 1110. The cushion pads 1130 may be disposed below the supporting frame 1120.

The vibration motor 1210 may be fastened to the carrier board portion 1112. The vibration driving axle 1220 may be an eccentric rod body and includes a main axle body 1221 and two eccentric protruding shaft portions 1222. The two eccentric protruding shaft portions 1222 are respectively protrude from two ends of the main axle body 1221. The vibration driving mechanism 1200 may further include a vibration driving wheel 1240, a vibration driving belt 1230 and two bearing brackets 1250. The vibration driving wheel 1240 sleeves on the vibration driving axle 1220. The vibration driving belt 1230 sleeves on the vibration motor 1210 and the vibration driving wheel 1240. The two bearing brackets 1250 are arranged at the carrier board portion 1112 at an interval along the X axis. The two ends of the main axle body 1221 may respectively penetrate the two bearing brackets 1250 to allow the two eccentric protruding shaft portions 1222 to expose from the two bearing brackets 1250. Therefore, the vibration motor 1210 may drive the vibration driving belt 1230 to rotate the vibration driving wheel 1240, allowing the vibration driving axle 1220 to rotate relative to the two bearing brackets 1250.

Each of the vibration linkage mechanisms 1300 may further include a transmission board 1310b, a supporting board 1320b and a vibrating arm 1330b. The transmission board 1310a, the supporting board 1320a and the vibrating arm 1330a forms one vibration assembly, the transmission board 1310b, the supporting board 1320b and the vibrating arm 1330b forms another vibration assembly, and the two vibration assemblies are independent from each other.

The vibration linkage mechanism 1300 on one side is taken as an example. As shown in FIGS. 2 and 4, the structure of the transmission board 1310b is identical to the structure of the transmission board 1310a, and the transmission board 1310b is parallel to a Z axis and includes an upper end and a lower end opposite to each other. The transmission board 1310a and the transmission board 1310b face to each other and the lower ends thereof are pivoted on the same eccentric protruding shaft portion 1222 on one of the sides. The transmission board 1310b is located between the transmission board 1310a and the main axle body 1221. The vibrating arm 1330a is pivoted on the upper end of the transmission board 1310a, the vibrating arm 1330b is pivoted on the upper end of the transmission board 1310b, and the vibrating arm 1330a and the vibrating arm 1330b extend to opposite direction. In other words, as shown in FIGS. 2, 4 and 6 and taken the eccentric protruding shaft portion 1222 as a center, the vibrating arm 1330a is located at a left side while the vibrating arm 1330b is located at a right side. The supporting board 1320a is fastened to the base 1100 and located on the left side of the eccentric protruding shaft portion 1222 for being pivoted on a middle section of the vibrating arm 1330a, and the outer side end of the vibrating arm 1330a may be directly pivoted on the swinging arm 1510. The supporting board 1320b is fastened to the base 1100 and located on the right side of the eccentric protruding shaft portion 1222 for being pivoted on a middle section of the vibrating arm 1330b, and the outer side end of the vibrating arm 1330b may be directly pivoted on the swinging arm 1520, thereby forming the two vibrating assemblies arranged along the Y axis to vibrate the suspension frame 1600 along the Z axis. In other embodiments, each of the vibration linkage mechanisms may include a single vibration assembly, and generate an a wave vibration. Furthermore, although a number of the vibration linkage mechanisms 1300 is two, in other embodiments, a single vibration linkage mechanism may be included, and the present disclosure is not limited thereto.

Moreover, each of the vibration linkage mechanisms 1300 may include two cushion posts 1340. The two cushion posts 1340 located at the same side may be disposed at the base 1100 and connected to the two vibrating arms 1330a, 1330b. Taken the vibrating arm 1330a as an example, the vibrating arm 1330a may include an arm portion 1331a and a protrusion 1332a. The arm portion 1331a is pivoted on the supporting board 1320a, and the protrusion 1332a is extended from the arm portion 1331a toward the base 1100. The cushion post 1340 includes a cushion post body 1343, a first screwing member 1341 and a second screwing member 1342. An extension direction of the cushion post body 1343 is parallel to the base 1100. The first screwing member 1341 is fastened to one end of the cushion post body 1343 to secure the cushion post body 1343 to the base 1100. The second screwing member 1342 is fastened to another end of the cushion post body 1343 and restricted to the protrusion 1332a.

Precisely, the cushion post body 1343 may be made by an elastic material such as rubber. The first screwing member 1341 may be fastened to a vertical board which is fastened to the base 1100, and thus the cushion post body 1343 is disposed on the base 1100 horizontally. Two ends of the arm portion 1331a are respectively defined as the inner side end and the outer side end. The protrusion 1332a may be located at the left side of the supporting board 1320a and include an engaging groove for a nut of the second screwing member 1342 to be fastened therein, thereby connecting the cushion post 1340 and the vibrating arm 1330a. Therefore, as the vibrating arm 1330a vibrates, the cushion post 1340 may provide a cushion effect. In other embodiments, the cushion post body may be disposed at the base vertically.

The rhythm device 1000 may further include two connecting rods 1710, 1720. The connecting rod 1710 is parallel to the X axis and connected between the two vibrating arms 1330a, the connecting rod 1720 is parallel to the X axis and connected between the two vibrating arms 1330b, and thus a lateral force is increased.

As shown in FIGS. 4 and 5, the swinging driving axle 1420 may have an eccentric axle structure. The swing motor 1410 may protrude into two adjacent crossbar portions 1111 and is fastened to at least one of the crossbar portions 1111. The swing driving mechanism 1400 may further include a decelerating belt 1430, a decelerating wheel 1440, a decelerating axle 1450, a swing driving wheel 1460 and a swing driving belt 1470. The decelerating belt 1430 sleeves on an output shaft of the swing motor 1410 and the decelerating wheel 1440. The decelerating axle 1450 penetrates the decelerating wheel 1440 to be rotated by the decelerating wheel 1440. The swing driving wheel 1460 sleeves on the swing driving axle 1420, and the swing driving belt 1470 sleeves on the decelerating wheel 1440 and the swing driving wheel 1460, thereby transmitting a decelerated rotating force to the swing driving axle 1420. In other embodiments, the decelerating belt, the decelerating wheel and the decelerating axle may be omitted, and the present disclosure is not limited thereto.

The swing linkage mechanism 1500 may further include two linking boards 1530. Two ends of each of the linking boards 1530 are respectively pivoted on one end of the swing driving axle 1420 and the swinging arm 1520. Therefore, the swing motor 1410 may drive the swing driving axle 1420 to rotate the linking board 1530, and thus the swinging arm 1520 swings horizontally. It is noted that, if the vibration linkage mechanism of one of the sides includes a single vibration assembly, the swinging arm pivoted by the linking board may be the same or different from the swinging arm pivoted by the vibration assembly. A number of the swinging arms may be equal to or more than two according to the demands, and is not limited thereto. In addition, some elements of the drawings may be connected by welding or manufactured to be a one-piece element, and the present disclosure is not limited by the drawings.

The suspension frame 1600 may include a top frame body 1610 and a connecting frame body 1620. The connecting frame body 1620 is connected below the top frame body 1610 and includes two disposing rods parallel to the X axis. One of the disposing rods is near the two swinging arms 1510 and is provided for the two swinging arms 1510 to be pivoted thereon. Another one of the disposing rods is near the two swinging arms 1520 and is provided for the two swinging arms 1520 to be pivoted thereon. Moreover, as shown in FIG. 1, the rhythm chair 100 may further include a chair frame 2000 disposed at the suspension frame 1600, especially the top frame body 1610 of the suspension frame 1600. Hence, as the suspension frame 1600 is vibrated or swung, the chair frame 2000 may also be vibrated or swung. In other embodiments, the suspension frame may have a case structure for a human body to stand on a top surface thereof, and the present disclosure is not limited to a rhythm chair.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A rhythm device, comprising:
a base;
a vibration driving mechanism disposed at the base and comprising a vibration motor and a vibration driving axle, wherein the vibration driving axle is rotated by the vibration motor;
a vibration linkage mechanism driven by the vibration driving mechanism eccentrically and comprising:
a transmission board comprising an upper end and a lower end opposite to each other, wherein the lower end is pivoted on one end of the vibration driving axle;
a supporting board comprising a fixed end and a pivoting end, wherein the fixed end is fixed at the base; and
a vibrating arm pivoted on the pivoting end and comprising an inner side end and an outer side end, wherein the inner side end is directly pivoted on the upper end of the transmission board;
a swing driving mechanism disposed at the base and comprising a swing motor and a swing driving axle, wherein the swing driving axle is rotated by the swing motor;
a swing linkage mechanism driven by the swing driving mechanism eccentrically and comprising four swinging arms, wherein the four swinging arms are arranged at two sides of the base symmetrically, each of the four swinging arms comprises a top end and a bottom end, and the top end of one of the four swinging arms is directly pivoted on the outer side end of the vibrating arm; and
a suspension frame pivoted on the bottom ends of the four swinging arms;
wherein the vibration motor drives the vibration driving axle to vibrate the vibrating arm with the pivoting end of the supporting board as a pivot, and the one of the four swinging arms is driven to vibrate the suspension frame; the swing motor drives the swing driving axle to drive the swing linkage mechanism, thereby swinging the suspension frame horizontally.

2. The rhythm device of claim 1, wherein the vibration linkage mechanism further comprises a cushion post disposed at the base and connected to the vibrating arm.

3. The rhythm device of claim 2, wherein the vibrating arm comprises an arm portion and a protrusion, the arm portion is pivoted on the supporting board, the protrusion is extended from the arm portion toward the base, the cushion post comprises a cushion post body, a first screwing member and a second screwing member, an extension direction of the cushion post body is parallel to the base, the first screwing member is fastened to one end of the cushion post body to secure the cushion post body to the base, and the second screwing member is fastened to another end of the cushion post body and restricted to the protrusion.

4. The rhythm device of claim 1, wherein the swing driving mechanism further comprises a linking board pivoted between one end of the swing driving axle and one of the four swinging arms.

5. A rhythm device, comprising:
a base;
a vibration driving mechanism disposed at the base and comprising a vibration motor and a vibration driving axle, wherein the vibration driving axle is rotated by the vibration motor;
two vibration linkage mechanisms disposed at two sides of the base symmetrically and driven by the vibration driving mechanism eccentrically, each of the vibration linkage mechanisms comprising:
a transmission board comprising an upper end and a lower end opposite to each other, wherein the lower end is pivoted on one end of the vibration driving axle;
a supporting board comprising a fixed end and a pivoting end, wherein the fixed end is fixed at the base; and
a vibrating arm pivoted on the pivoting end and comprising an inner side end and an outer side end, wherein the inner side end is directly pivoted on the upper end of the transmission board;
a swing driving mechanism disposed at the base and comprising a swing motor and a swing driving axle, wherein the swing driving axle is rotated by the swing motor;
a swing linkage mechanism driven by the swing driving mechanism eccentrically and comprising two swinging arms, wherein the two swinging arms are arranged at the two sides of the base symmetrically, each of the two swing arms comprises a top end and a bottom end, the top end of the swinging arm located at one of the two sides is directly pivoted on the outer side end of one of the vibrating arms, and the top end of the swinging arm located at another one of the two sides is directly pivoted on the outer side end of another one of the vibrating arms; and
a suspension frame pivoted on the bottom ends of the two swinging arms;
wherein the vibration motor drives the vibration driving axle to vibrate the vibrating arm with the pivoting end of the supporting board as a pivot, and the two swinging arms are driven to vibrate the suspension frame; the swing motor drives the swing driving axle to drive the swing linkage mechanism, thereby swinging the suspension frame horizontally.

6. The rhythm device of claim 5, wherein each of the vibration linkage mechanisms further comprises a cushion post, and the two cushion posts are disposed at the base and respectively connected to the two vibrating arms.

7. The rhythm device of claim 6, wherein:
each of the two vibrating arms comprises:
an arm portion pivoted on one of the two supporting boards; and
a protrusion extended from the arm portion toward the base; and
each of the two cushion posts comprises:
a cushion post body, wherein an extension direction of the cushion post body is parallel to the base;
a first screwing member fastened to one end of the cushion post body to secure the cushion post body to the base; and
a second screwing member fastened to another end of the cushion post body and restricted to one of the two protrusions.

8. The rhythm device of claim 5, the swing driving mechanism further comprises two linking boards respectively pivoted on two ends of the swing driving axle, thereby swinging the suspension frame horizontally.

9. The rhythm device of claim 5, further comprising a connecting rod connected between the two vibrating arms.

10. A rhythm chair, comprising:
the rhythm device of claim 5; and
a chair frame disposed at the suspension frame.
